(19) United States
(12) Patent Application Publication
(10) Pub. No.: US 2024/0365731 A1
(43) Pub. Date: Nov. 7, 2024

(54) DEVICE, SYSTEM, AND METHOD FOR HYDROPONIC FARMING

(71) Applicants: Mason Sufnarski, Waxhaw, NC (US); Josie Barber, Mercer Island, WA (US)

(72) Inventors: Mason Sufnarski, Waxhaw, NC (US); Josie Barber, Mercer Island, WA (US)

(21) Appl. No.: 18/654,325

(22) Filed: May 3, 2024

Related U.S. Application Data
(60) Provisional application No. 63/464,091, filed on May 4, 2023.

(51) Int. Cl. A01G 31/02; A01G 31/00

(52) U.S. Cl. CPC A01G 31/02; A01G 2031/006

(57) ABSTRACT

Devices, methods, and systems for hydroponic farming are provided. An example device includes a basin that is configured to collect greywater or other aqueous solutions. The device also includes a filtration column in fluid communication with the basin that includes a filtration material therein and receives the aqueous solution from the basin. The device further includes one or more dispersion tubes in fluid communication with the filtration column. In operation, the aqueous solution received by the basin is directed through the filtration column such that the filtration material removes impurities within the aqueous solution before the aqueous solution is directed to the at least one dispersion tube. The filtered aqueous solution may be used in hydroponic farming implementations.

### CROSS-REFERENCE TO RELATED APPLICATIONS

This application claims the benefit of U.S. Provisional Patent Application. No. 63/464,091, filed May 4, 2023, the entirety of which is incorporated herein by reference.

### FIELD

Embodiments of the present disclosure relate generally to agriculture and sustainability and, more particularly, to the field of recycling water for use in hydroponic farming.

### BACKGROUND

Many parts of the world either consistently or intermittently experience water scarcity that has a negative impact on its inhabitants by limiting their access to adequate resources for hydration and farming. Current solutions in areas experiencing water scarcity include digging additional wells or boreholes and importing water from other areas. However, these solutions are costly and may present logistical barriers, particularly for low-income individuals. Applicant has identified a number of deficiencies and problems associated with agriculture and sustainability. Through applied effort, ingenuity, and innovation, many of these identified problems have been solved by developing solutions that are included in embodiments of the present disclosure, many examples of which are described in detail herein.

### BRIEF SUMMARY

One or more embodiments of the present disclosure may address one or more of the aforementioned problems. Devices, systems, and methods for recycling greywater for hydroponic farming purposes are provided herein. With reference to an example hydroponic farming device, the device may include a basin, a filtration column in fluid communication with the basin via a first valve and formed of filtration piping defining at least a first open space therein, a filtration material disposed within the first open space, and at least one dispersion tube in fluid communication with the filtration column via a second valve. At least the first open space is configured to receive a filtration material. Further, the dispersion tube comprising dispersion piping defines a second open space. When the hydroponic farming device is operated, the aqueous solution received by the basin is directed through the first open space such that the filtration material removes at least a portion of the impurities within the aqueous solution before the aqueous solution is directed to the at least one dispersion tube.

In some embodiments, the first open space may be configured to receive a filtration material that may include or be formed of a natural material. For example, in certain embodiments, the filtration material may include rocks, sand, charcoal, wood chips, or a combination thereof.

In certain embodiments, the dispersion tube may be configured to receive at least one crop therein. In some embodiments, the dispersion tube further includes a draining mechanism configured to drain excess fluid. For example, the dispersion tube may include a manipulatable cover, such as a hinged cover. In some embodiments, the manipulatable cover may be transparent. In some embodiments, draining mechanism may include a drain valve operably coupled to the dispersion tube and configured to drain a liquid from the hydroponic farming device.

In some embodiments, the at least one dispersion tube may be operably coupled to a plurality of tubes. For example, the at least one dispersion tube may be operably coupled to two tubes, three tubes, four tubes, or five or more tubes. In embodiments that have a dispersion tube operably coupled to four tubes, the second valve may be a five-way valve. In some embodiments, the plurality of dispersion tubes may be linearly coupled.

In certain embodiments, the dispersion tube may be a single dispersion tube. In other embodiments, the dispersion tube may be formed from more than one tube. For example, the dispersion tube may be formed from two tubes, three tubes, four tubes, or five or more tubes. In some embodiments that have a dispersion tube operably coupled to four tubes, the second valve may be a five-way valve.

In some embodiments, the basin is in fluid communication with a top portion of the filtration column. In some embodiments, the filtration column may be in fluid connection with a top portion of the dispersion tube. In some embodiments, the dispersion tube(s) of the hydroponic farming device may serve as a structural support for the hydroponic farming device.

According to certain embodiments, the first valve may be a ball valve.

In some embodiments, the basin may include or be formed of a plastic material.

In some embodiments, the piping may include or be formed of a transparent material. In other embodiments, the piping may include or be formed of bamboo.

With reference to an example system for hydroponic farming. The system includes a hydroponic farming device and a filtration material. The hydroponic farming device includes a basin configured to receive an aqueous solution (for example, greywater); a filtration column in fluid communication with the basin via a first valve and formed of filtration piping defining at least a first open space configured to receive a filtration material; a filtration material disposed within the first open space; and at least one dispersion tube in fluid communication with the filtration column via a second valve.

According to some embodiments, the filtration material includes or is formed of a natural material or a combination of natural materials. In some embodiments, the filtration material includes or is formed of any of rocks, sand, charcoal, wood chips or a combination thereof.

According to some embodiments, the filtration column of the system for hydroponic farming may further include a strainer. The strainer may be disposed at the bottom of the filtration column. Additionally or alternatively, strainer may be disposed within the filtration column. In some embodiments, the system includes a geotextile proximate to the strainer.

In some embodiments, the dispersion tube further includes a draining mechanism configured to drain an excess fluid from the dispersion tube. In some such embodiments, the draining mechanism includes a manipulatable cover (for example a hinged cover). In some embodiments, at least a portion of the manipulatable cover may be formed from a transparent material. In some embodiments, the means for draining excess fluid includes a drain valve which may be operably coupled to the dispersion tube.

In some embodiments, the dispersion tube defines and opening configured to receive at least one crop therein. In some embodiments, the at least one dispersion tube may be in fluid connection with a plurality of tubes. For example, the at least one dispersion tube may be in fluid connection with two tubes, three tubes, four tubes, or five or more tubes.

In certain embodiments, the at least one dispersion tube is formed of a plurality of tubes. In some embodiments, the at least one dispersion tube is formed of two tubes. In other embodiments, the at least one dispersion tube is formed of three tubes. In some embodiments, the at least one dispersion tube is formed of four tubes. In still other embodiments, the at least one dispersion tube is formed of five or more tubes.

In another aspect, a method of hydroponic farming is provided. The method of hydroponic farming includes collecting an aqueous solution in a hydroponic farming device, the hydroponic farming device comprising a basin configured to receive an aqueous solution, a filtration column in fluid connection with the basin via a first valve and formed of filtration piping defining at least a first open space, and at least one dispersion tube defining a second open space and in fluid communication with the filtration column via a second valve; manipulating the first valve to allow the aqueous solution to flow from the basin into at least one open space in the filtration column, and manipulating the second valve to allow the aqueous solution to flow from the open space of the filtration column to the at least one dispersion tube. In the hydroponic farming device, at least the first open space is configured to receive a filtration material such that, when the hydroponic farming device is operated, the aqueous solution received by the basin is directed through the first open space such that the filtration material removes at least a portion of the impurities within the aqueous solution.

In some instances, the Kratky Method (as later defined here) is utilized. In some embodiments, the aqueous solution may be an aqueous solution. In further embodiments, the aqueous solution may include of greywater (either in part or in full).

In some instances, the method may further include a user cleansing one or more anatomical parts in the aqueous solution. Additionally or alternatively, the method may include a user cleansing one or more wearable items in the aqueous solution.

In yet another aspect, a method for recycling greywater is provided. The method includes collecting greywater in a basin that is in fluid communication with a filtration column via a first valve; manipulating the first valve to allow the greywater to fill a first open space in the filtration column; manipulating a second valve to allow the greywater to enter an open space defined by a dispersion tube, which is operably coupled to the filtration column via the second valve; and manipulating the second valve in order to allow the aqueous solution to flow from the open space configured to receive a filtration material to the at least one dispersion tube.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE SEVERAL VIEWS OF THE DRAWING(S)

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 is a perspective view of an example hydroponic farming device in accordance with one or more embodiments of the present disclosure;

FIG. 2 is a side view of the hydroponic farming system of FIG. 1 showing a cutaway view of a portion of the filtration column, in accordance with one or more embodiments of the present disclosure;

FIG. 3 is a block diagram of a method of hydroponic farming according to one or more embodiments of the present disclosure; and

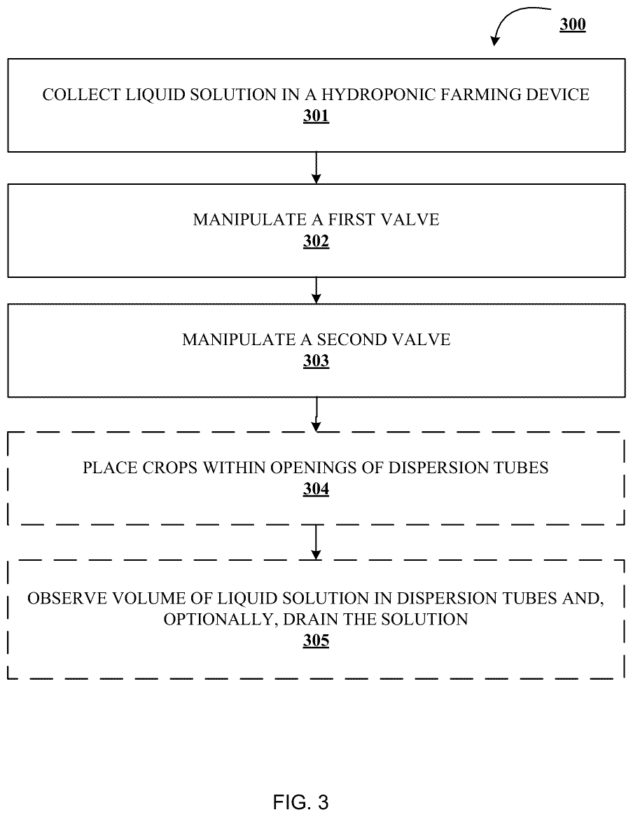

FIG. 4 is a block diagram of a method of greywater (e.g., aqueous solution) recycling according to one or more embodiments of the present disclosure.

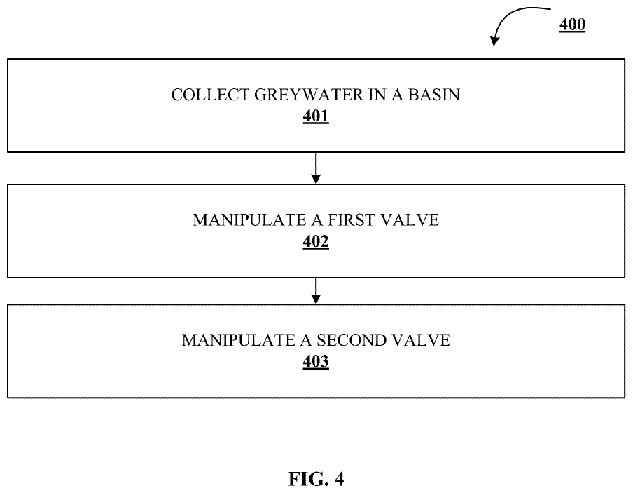

### DETAILED DESCRIPTION

Embodiments of the present disclosure now will be described more fully hereinafter with reference to the accompanying drawings, in which some, but not all embodiments of the inventions are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise. Furthermore, as would be evident to one of ordinary skill in the art in light of the present disclosure, the terms “substantially” and “approximately” indicate that the referenced element or associated description is accurate to within applicable engineering tolerances.

As described above, water shortages create a significant barrier to traditional farming approaches, particularly in low-income regions of the world, and may ultimately lead to wide-spread food insecurity in these regions. Conventional solutions in these areas (e.g., digging additional wells, importing water from other areas, etc.) are costly and may present logistical barriers, particularly for low-income individuals. In order to solve these problems and others, the methods and devices of the present disclosure may leverage the use of greywater (e.g., an example aqueous solution) to grow crops. Current techniques that attempt to use greywater for farming, however, often impact soil health and crop growth, increase the pH levels of the soil, and/or increase crops proclivity to develop E. coli and other pathogens.

In order to reuse greywater effectively to conserve water, embodiments of the present disclosure may use a Kratky-based Method of hydroponic farming as a means to reuse greywater to grow crops. When the Kratky Method of hydroponic farming is used, crops are suspended above water such that they are able to access the necessary nutrients for growth. Because the Kratky Method is a non-circulating method of hydroponics, forced circulation systems (e.g., pumps or the like) are not needed and no additional inputs such as water or nutrients are required. Therefore, this method may be used in locations where resources (e.g., space for planting) is limited. Furthermore, many crops may only flourish in an environment where they have access to water that is slightly acidic, but the exact pH necessary for growth may vary. The devices, systems, and methods described herein may also be used to achieve a pH range that is appropriate for various types of crops. Further, some of the embodiments described herein may be used to achieve the ideal pH range for a particular crop while other embodiments may be more well-suited for a different type of crop.

Although the devices, systems, and methods of the present disclosure are described herein with reference to example issues in subsistence agriculture, these embodiments may also be applicable to commercial agriculture implementations. Therefore, nothing herein should be interpreted as limiting use of the device, system or method to subsistence agriculture.

### Definitions

As used herein, the terms “agriculture” and “farming” may refer to both subsistence agriculture and commercial agriculture. As would be evident to one of ordinary skill in the art, “commercial agriculture” may refer to the growth of crops for sale, trade, etc. As would be evident to one of ordinary skill in the art, “subsistence agriculture” or “subsistence farming” may refer to the growth of crops for personal, community, or familial use. Although described herein with reference to agriculture and farming implementations, the embodiments of the present disclosure may be applicable to any industry, application, or the like in which the filtration of aqueous solutions is advantageous.

As used herein, unless otherwise stated, the term “crop” may be inclusive of any plant, such as those grown for consumption as food, for aesthetic purposes, for medicinal purposes, and/or the like without limitation. As used herein, “hydroponic agriculture” or “hydroponic farming” may refer to the soilless cultivation of crops, plants, etc. in an aqueous solution as defined hereinafter. As used herein, the “Kratky Method” or “a Kratky-based Method” of hydroponic farming may refer any farming method where crops are suspended above or otherwise in fluid communication with an aqueous solution in a way that allows them to utilize the water and nutrients, such as those provided below, to aid in growth of the crop. Although described herein with reference to the Kratky Method, the present disclosure contemplates that the devices, systems, and methods described herein may leverage any method, technique, etc. by which aqueous solutions are filtered for use with hydroponic farming.

As used herein, a “natural material” is a material including one or more naturally occurring elements, items, or materials. Natural materials include, but are not limited to, rocks, sand, charcoal, wood chips, animal hair, and/or the like.

As used herein, the term “geotextile” may refer to a permeable textile fabric or material.

As used herein, the terms “anatomical part” or “anatomical parts” may refer to any body part of any animal, including but not limited to, human body part(s).

As used herein, the terms “aqueous solution” may refer to any mixture, solution, suspension, or emulsion comprising water. An aqueous solution as used herein is not limited to solutions where impurities are fully dissolved, but also includes solutions having solid particles, particulates, etc. that may form sedimentation. Furthermore, an aqueous solution may include solutions in which another fluid is suspended in water (e.g., an emulsion).

As used herein, the term “greywater” may refer to an aqueous solution produced by any use of water that may introduce impurities such as bacteria, viruses, particulate matter, and/or the like into the water. For example, greywater may be produced during activities such as bathing, hand-washing, washing clothes or dishes, and/or the like. While the actions that produce greywater, as discussed throughout, often reference household actions, greywater may also result from commercial or industrial activities.

As used herein, the term “comprising” is synonymous with “including,” “containing,” or “characterized by,” and is inclusive or open-ended and does not exclude additional, unrecited elements or method steps. Further, where “comprising” is used, unless otherwise stated, it is intended to encompass embodiments that comprise the step or element, embodiments that consist essentially of the step or element, and embodiments consisting of the step or element.

### Hydroponic Farming Device

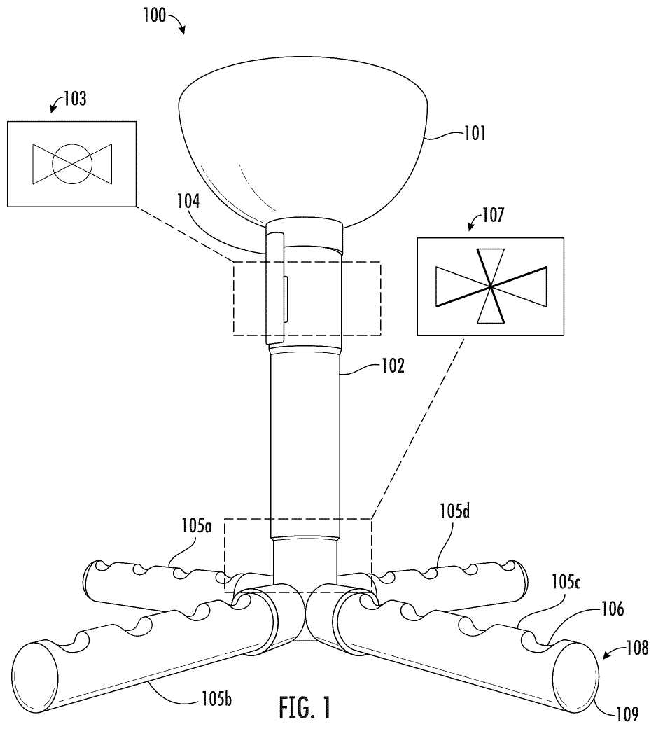

With reference to FIG. 1, an example hydroponic farming device 100 (e.g., device 100) is illustrated. The hydroponic farming device 100 may include a basin 101 configured to receive an aqueous solution (e.g., greywater or the like). As shown, the basin 100 may define at least an opening for receiving the aqueous solution. In some embodiments, such as in an instance in which gravity drives movement of the aqueous solution within the device 100 (e.g., a passive solution), such an opening may be position vertically at the top of the device 100 during operation. In other embodiments, such as in an instance in which the aqueous solution is at least partially forced through the device 100 via an external device, system, etc. (e.g., an active solution), the opening of the basin 100 may be positioned at any location on the body defining the basin 101. By way of a nonlimiting example, the device 100 may be connected to or otherwise associated with a pump or other positive pressure source, a vacuum or other negative pressure source, and/or the like. In some embodiments, the basin 101 may include or otherwise be formed of a plastic material. In other embodiments, the basin 101 may include or otherwise be formed of a natural material, such as bamboo. Although described herein with reference to plastics and natural materials, the present disclosure contemplates that any material applicable to hydroponic farming may be used to form the basin 101.

With continued reference to FIG. 1, the body of the basin 101 may taper along its length. For example, the cross-sectional area associated with the body of the basin 101 at the opening that receives the aqueous solution may be greater than the cross-sectional area of the basin at the connection between the basin 101 and the filtration column 102. In some embodiments, the basin 101 may by conical in shape and have a circular cross-sectional shape. Although illustrated and described with reference to an example conical shape, the present disclosure contemplates that the basin may be dimensioned (e.g., sized and shaped) based on the intended application of the device 100. Furthermore, although the basin 101 is described as an independent or separate element of the device 100 (e.g., a modular solution), the present disclosure contemplates that, in some embodiments, the basin 101 may be formed integral with the filtration column 102 (e.g., an integrated solution).

The basin 101 may be fluidly connected to a filtration column 102 below it via a first valve 103 such that when the valve is in an open position (i.e., allowing flow between the basin 101 and the filtration column 102), an aqueous solution contained within the basin 101 may flow into an open space in the center of the filtration column (when the filtration column is viewed cross-sectionally). In some embodiments, such as in an instance where the valve is manipulated by a user (either directly or indirectly) (e.g., an actively-controlled valve), the valve may be a ball valve, a binary valve, a three-way valve, and/or the like. In other embodiments, the valve may be a passively-controlled valve such as, for example, a valve that moves from a closed position to an open position in response to a threshold amount of downward pressure being exerted on the valve by the aqueous solution within the basin.

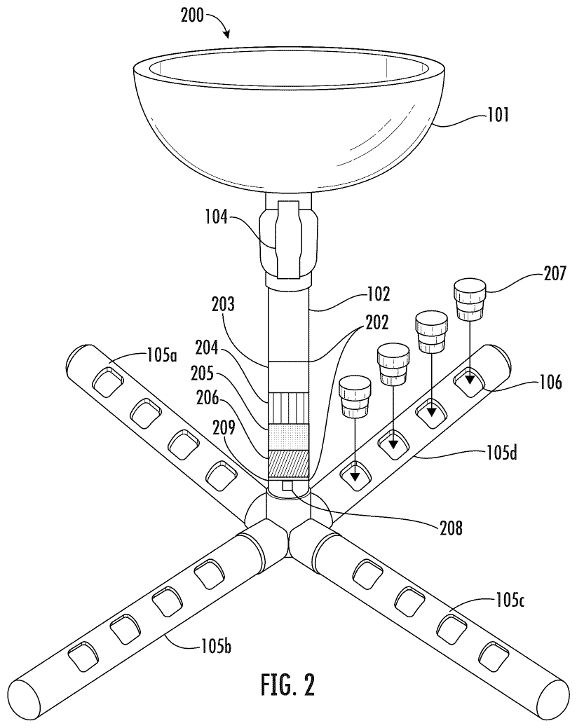

In instances where the valve is an actively-controlled, the valve may be manipulated via a control means, such as a knob, a switch and the like, In the example depicted in FIG. 2, the valve is manipulated by a knob 104. The control means for manipulating the valve may be manipulated manually or remotely using a control mechanism. In some embodiments, such as where the valve is manipulated by a control mechanism, the control mechanism may be controlled by a user to manipulate the valve. Additionally or alternatively, the control mechanism may be configured to communicate with an external device and manipulate the valve in response to instructions received by the control mechanism from the external device. The present disclosure contemplates that the device 100 may leverage any mechanism for selectively providing fluid communication between the fluidically coupled portions of the device 100 without limitation.

The filtration column 102 may be formed from a piping material. Optionally, a transparent piping material may be used. As used herein, the term “piping” includes but is not limited to traditional piping materials such as PVC. In one example, the piping may be comprised of bamboo or any other material. In certain embodiments, the open space within the filtration column 102 may be fully enclosed except for at its connection to the basin 101 and the dispersion tube. In some embodiments, the filtration column 102 may have a consistent cross-sectional area from the connection point between the basin 101 and the filtration column 102 to the connection between the filtration column 102 and the dispersion tube(s) (105a, 105b, 105c, 105d). In some embodiments, the cross-sectional area of the filtration column at the connection point between the basin 101 and the filtration column 102 may be greater than the cross-sectional area of the filtration column 102 at the connection between the filtration column 102 and the dispersion tube(s) (105a, 105b, 105c, 105d). In some embodiments, the filtration column may have a variable cross-sectional area as it extends from the connection point between the basin 101 and the filtration column 102 may be greater than the cross-sectional area of the filtration column 102 at the connection between the filtration column 102 and the dispersion tube(s) (105a, 105b, 105c, 105d). For example, the cross-sectional area may be greater at the point where the filtration material is disposed within the filtration column to accommodate the filtration material. Alternatively, the cross-sectional area may be smaller at point where the filtration material is disposed within the filtration column in order to ensure a friction-fit. Although described herein with reference to piping forming the filtration column 102, the present disclosure contemplates that any structure through which fluid (e.g., the aqueous solution) may flow may be used. Said differently, the piping of the present disclosure may refer to any channel, conduit, duct, tube and/or the like through which an aqueous solution may flow.

The open space defined by the tubing of the filtration column 102 may be configured to receive a filtration material 202 configured to filter an aqueous solution as it passes through the filtration column 102. In some embodiments, the filtration column 102 may be configured to receive natural materials such as rocks, sand, charcoal, wood chips, and the like. In some embodiments, the internal surface of the piping defining the filtration column 102 may include features for inhibiting movement of the filtration materials 202 within the filtration column 102, for example indentions, texturing, and/or the like.

As shown, the dispersion tubes 105a, 105b, 105c, 105d may be operably coupled to the filtration column 102 such that after passing through the filtration column 102, the aqueous solution may be released into the open space within the dispersion tubes 105a, 105b, 105c, 105d. In certain embodiments, the filtration column 102 may be positioned above the dispersion tubes 105a, 105b, 105c, 105d to facilitate flow of the aqueous solution and provide structural support for the device 100. Although the embodiment shown in FIG. 1 includes four (4) dispersion tubes 105a, 105b, 105c, 105d, any number of dispersion tubes 105a, 105b, 105c, 105d may be used. For example, alternative embodiments may include two tubes, three tubes, four tubes, or five or more tubes. Further, dispersion tubes 105a, 105b, 105c, 105d may be linearly coupled (i.e. the proximal end of one dispersion tube may be coupled to the distal end of another dispersion tube). In some embodiments, the at least one dispersion tube may be operably coupled to a plurality of dispersion tubes.

In order to facilitate growth of crops, the dispersion tubes 105a, 105b, 105c, 105d may include openings 106 in the external material forming the dispersion tube (e.g., piping or tubing). When crops are placed in the openings 106, they are suspended such that they are either above or otherwise in contact with an aqueous solution if any is disposed within the dispersion tube 105a-105d. In some embodiments, crops may be placed in a basket before being inserted into the openings 106. In some embodiments, the openings 106 may have features for inhibiting the movements of crops when the device 100 is moved. For example, the openings 106 may include a lip for holding a basket containing crops in place.

In some embodiments, a second valve 107 located at the junction of the filtration column 102 and the dispersion tubes 105a, 105b, 105c, 105d may be configured to control flow of the aqueous solution into the dispersion tubes 105a, 105b, 105c, 105d. When in an open position, the second valve 107 facilitates flow of the aqueous solution into each of the dispersion tubes 105a, 105b, 105c, 105d. In some embodiments, such as in an instance where the valve is manipulated by a user (either directly or indirectly) (e.g., an actively-controlled valve), the second valve may be a ball valve, a binary valve, a three-way valve and the like. In other embodiments, the second valve may be a passively-controlled valve such as, for example, a valve that moves from a closed position to an open position in response to a threshold amount of pressure being exerted on the valve by the aqueous solution within the filtration column.

In instances where the valve is an actively-controlled, the valve may be manipulated via a control means, such as a knob, a switch, and/or the like. The control means for manipulating the valve may be manipulated manually or remotely using a control mechanism. In some embodiments, such as where the valve is manipulated by a control mechanism, the control mechanism may be controlled by a user to manipulate the valve. Additionally or alternatively, the control mechanism may be configured to communicate with an external device and manipulate the valve in response to instructions received by the control mechanism from the external device. As above, the present disclosure contemplates that the device 100 may leverage any mechanism for selectively providing fluid communication between the fluidically coupled portions of the device 100 without limitation.

A distal end 108 of each of the dispersion tubes 105a, 105b, 105c, 105d may include a draining mechanism. In some embodiments, the draining mechanism is a cover 109. In some embodiments, the cover 109 may be a manipulatable cover. In certain embodiments, the manipulatable cover may be a hinged cover. Additionally or alternatively, the hydroponic farming device 100 may include a drain valve (not shown). In such embodiments, when the drain valve is manipulated, the aqueous solution is released from the dispersion tubes 105a, 105b, 105c, 105d, thereby ensuring that an optimal volume of solution is contained within the dispersion tubes 105a, 105b, 105c, 105d. The drain valve may have any of the characteristics discussed above with respect to the second valve 107. The draining mechanism may be manipulated manually or via a remote control means.

In some embodiments, a distal end 108 the dispersion tubes 105a, 105b, 105c, 105d may include a transparent material or semi-transparent material. Use of a transparent material allows a user to optically determine the volume of aqueous solution in the dispersion tubes 105a-105d. Additionally or alternatively, the dispersion tubes 105a-105d may be open at a top portion (i.e., “cut away”) such that the aqueous solution is uncovered and viewable by the user. In embodiments including a manipulatable cover, the manipulatable cover may be transparent or semi-transparent. In additional or alternative embodiments, the volume of aqueous solutions contained within the dispersion tubes 105a, 105b, 105c, 105d may be measured through other means. For example, in some embodiments, a sensor may be used to measure the volume of the aqueous solution. In such embodiments, the sensor may be configured to sense the volume of aqueous solution within the one or more of the dispersion tubes and alert a user (e.g., by emitting an alarm or, alternatively via communication with an external device) that draining of the aqueous solution is needed. In further embodiments, the volume of aqueous solution contained within the dispersion tubes 105a, 105b, 105c, 105d may be measured using a dip stick.

Notably, the hydroponic farming device 100 may be constructed in various sizes by varying the size of any of the basin 101, the filtration column 102, or the dispersion tubes 105a, 105b, 105c, 105d. The device 100 may also be constructed with a stand or other height-enhancing mechanism. The ability to vary the height of the device 100 serves to facilitate collection of greywater produced from various activities for use as the aqueous solution. In some embodiments, the device is about two feet in height, in some embodiments the device is about three feet tall, in still other embodiments the device is about four feet tall, in some embodiments the device is about five feet tall, in some embodiments the device is about six feet tall or taller. In some embodiments, the height-enhancing element may be adjustable such that it is configured to receive an aqueous solution at a first height and then may be adjusted to a preferred height for growth and collection of crops using the Kratky Method.

### System for Hydroponic Farming

With reference to FIG. 2, a device for hydroponic farming is shown as part of a system for hydroponic farming 200. As illustrated in FIG. 2, the filtration column 102 of the device is shown with a cutaway to illustrate a cross-sectional view of the inside of the filtration column 102. The system 200 includes a hydroponic farming device, a filtration material 202, and an aqueous solution (not pictured). In some embodiments, the aqueous solution includes greywater (either in whole or in part).

The filtration material 202 may be formed from a singly material or a variety of materials. Such materials may be layered or combined into a material blend. As illustrated in FIG. 2, the filtration material 202 may include four (4) layers of material 203, 204, 205, 206 as further discussed below. Further, the filtration material 202 may include a single or various natural materials, either in whole or in part. Such natural materials may include rocks, sand, wood chips, corn cob, gravel, sediment, and the like.

The filtration material 202 selected operates to provide a filtered solution (i.e., the product resulting from flow of the aqueous solution through the filtration column 102 and the filtration materials 202 that are operably coupled thereto) that is slightly acidic, in some embodiments having a pH value that is between 5.0 and 7.8. The filtered solution may have a pH that is about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5 about 6.6, about 6.7, about 6.8, about 6.9, about 7.1 about 7.2, about 7.3, about 7.4, about 7.5, about 7.6, about 7.7, or about 7.8.

The filtration material 202 may be disposed within the hydroponic farming device 100 in a variety of ways. In some embodiments, the filtration material 202 may be disposed within the filtration column 102. In certain embodiments, the filtration material 202 may optionally be strategically layered within the filtration column 102. Where the filtration material 202 inlcudes a combination of materials, the materials may be strategically layered for optimal filtration. For example, as depicted in FIG. 2, the filtration material 202 has a first layer 203 comprising wood chips, a second layer 204 comprising sand, a third layer 205 comprising small rocks, and a fourth layer 206 comprising sand. In some embodiments, larger materials may be placed on the top such that the aqueous solution will contact the larger material first. Alternatively, smaller materials may be placed on the top such that the aqueous solution will contact the smaller materials first. In another embodiments, strategic layering is exemplified by layering smaller material between layers of relatively larger materials. In alternative embodiments, the filtration material 202 may be a unitary filter device which may be disposed within the filtration column 102. As would be evident to one of ordinary skill in the art in light of the present disclosure, the selection of the filtration material 202, the ordering of the components of the filtration materials, and/or the like may vary based on the particular aqueous solution received by the device 100.

In some embodiments, a strainer 208 and/or a geotextile 209 may optionally be disposed at the bottom of the filtration column 102 to provide additional filtration and support. The strainer 208 may be formed of or include a metal, a plastic, or a textile material (e.g., a cheesecloth or the like). In some embodiments, the strainer 208 may include a rounded disk having holes therein for collecting sediment that is in the aqueous solution while allowing water to flow through such holes. In another embodiment, the strainer 208 may be formed of a porous material for collecting sediment that is in the aqueous solution while allowing water to flow through the pores of the material. In some embodiments, the geotextile 209 may include a woven or non-woven material. In some embodiments, the geotextile 209 may be formed of or include polymer or polymer blend (for example, polypropylene, polyester, or a combination thereof). In some embodiments, the geotextile 209 may be positioned above the strainer. In other embodiments, the geotextile 209 may be positioned below the strainer 208. In an alternative embodiment, the geotextile 209 and the strainer 208 may be coupled to each other to improve convenience of installation within the filtration column. In yet another embodiment, the geotextile 209 and the strainer 208 may be integrally formed.

FIG. 2 further illustrates a basket 207 for placing a crop. The openings 106 within the dispersion tubes 105a, 105b, 105c, 105d may be designed such that they are configured to support the basket 207, thereby suspending a crop (not shown) such that it is either above or in contact with the aqueous solution disposed within the dispersion tube. In instances in which the dispersion tubes 105a-105d are open at a top portion, the dispersion tubes 105a-105d may include additional features for supporting the basket or a crop such as wires, netting, and the like.

### Method of Hydroponic Farming

In some embodiments, a method of hydroponic farming 300 is provided. The method of hydroponic farming includes a first step 301 of collecting an aqueous solution in a hydroponic farming device. The first step 301 may be carried out through washing anatomical body parts in the basin 101, for example hand-washing. In another instance, the first step 301 may be conducted by washing wearable or household items such as clothing or cooking and eating utensils. In another instance, first step 301 may be carried out through the collection of rainwater. The aqueous solution may be initially collected within the basin 101 of the hydroponic farming device 100 or it may be collected in an external device which may be emptied into the basin 101 (thereby collecting the aqueous solution in the device). One example of where collection of an aqueous solution in the basin from an external device is where the aqueous solution was previously used for bathing.

The second step 302 of the method of hydroponic farming includes manipulating a first valve 103 to allow the aqueous solution to flow from the basin 101 into the filtration column 102. As discussed above, the first valve 103 of the hydroponic farming device may be manipulated in a variety of ways, including through manual or electronic means (or via any other non-manual means of valve control). In some embodiments, the first valve may be manipulated by a user via a remote control. In instances where the hydroponic farming device includes a sensor, the valve may be manipulated automatically once the sensor indicates the desired volume of aqueous solution has been received by the basin.

The third step 303 of the method of hydroponic farming includes manipulating the second valve 107 to allow the aqueous solution to flow from the open space of the filtration column 102 to the dispersion tubes 105a, 105b, 105c, 105d. Manipulation of the second valve may be achieved using any of the methods described for manipulation of the first valve.

In some instances, the method may be carried out in order to facilitate the growth of crops using the Kratky Method. Where the Kratky Method is utilized, crops may be placed in container, such as a netted pot for suspension above the aqueous solution contained in the dispersion tubes. In some embodiments, a growing medium (for example, soil) may be incorporated into the aqueous solution or included in the netted pot. In instances where the Kratky Method is utilized, the method of the present disclosure may further include a fourth step 304 of placing a crop within the opening 106 in the external material of the dispersion tubes 105a, 105b, 105c, 105d.

The method may further include a fifth step 305 comprising observing or measuring the volume of aqueous solution flowing from the filtration column 102 to any of the dispersion tubes 105a, 105b, 105c, 105d and, optionally, draining some or all of the aqueous solution from the dispersion tube(s) 105a, 105b, 105c, 105d via a drainage mechanism such as a manipulatable cover or valve disposed upon or coupled to the dispersion tube(s) 105a, 105b, 105c, 105d. This step may be used where dispersion tubes 105a, 105b, 105c, 105d include a transparent or semi-transparent material or where the dispersion tubes 105a, 105b, 105c, 105d have a transparent or semi-transparent cover. The fifth step 305 may also be implemented in alternative embodiments where the volume of the solution in the dispersion tube is perceptible to the user by other means (such as those discussed above with respect to the device and system for hydroponic farming). For example, in instances where sensors are incorporated, or where a dip stick is used to ascertain the height of the solution within the dispersion tubes.

### Method for Recycling Greywater

In yet another aspect, a method for recycling greywater 400 is provided. The first step of the method 401 includes collecting greywater in a basin that is fluidly connected to a filtration column via a first valve. The second step of the method 402 includes manipulating the first valve thereby allowing the greywater to fill a first open space in the filtration column. The third step of the method 403 includes manipulating a second valve, thereby allowing the greywater to enter an open space defined by a dispersion tube, which is operably coupled to the filtration column via the second valve.

In some instances, the method further includes utilizing the filtered greywater for hydroponic farming. In another instance, the filtered greywater may be used for soil-based or other traditional farming or agriculture methods, particularly in the case of subsistence farming. In yet another instance, the method may further include use of the filtered greywater for drinking by humans or animals.

### EXAMPLES

### Example 1

In a first example, various filtration materials were used with the device to determine the pH value of different aqueous solutions achieved by filtering each of the aqueous solutions through the device when coupled with each of the filtration materials.

### Preparation of Filtration Materials

The table below illustrates the composition of each of the filtration materials. The materials comprising each filtration material are listed from top layer (i.e., coming in contact with the solution first) to bottom layer (i.e., coming in contact with the solution last). A geotextile was used with two of the four samples.

TABLE 1
Composition of filtration materials.

| | | Geotextile |
|---|---|---|
| Filter | Filter Material | used? |
| 1 | Small rock, sand, small rock, and large rock | No |
| 2 | Wood chips, small rock, sand, small rock, large rock | No |
| 3 | Cheesecloth, corn, small rock, sand, small rock, | Yes |
| | large rock, geotextile | |
| 4 | Cheesecloth, woodchips, corn, small rock, sand, | Yes |
| | small rock, large rock, geotextile | |

### Filtration and Results:

Each of clean water, greywater, and a greywater-chlorine combination were filtered through each of the filters. The pH of each of the aqueous samples was measured both before and after filtration. The results of samples filtered through each of filters 1-4 are shown below in Table 2.

TABLE 2
pH of samples before and after filtration.

| Clean Water | | Greywater | | Combination | |
|---|---|---|---|---|---|
| Initial | Filtered | Initial | Filtered | Initial | Filtered |

Filter 1

| | | | | | | |
|---|---|---|---|---|---|---|
| Chlorine | 0 | 0 | 0 | 0 | 0.25 | 0 |
| pH | 6.2 | 6.4 | 5.8 | 6.2 | 5.6 | 6.3 |

Filter 2

| | | | | | | |
|---|---|---|---|---|---|---|
| Chlorine | 0 | 0 | 0 | 0 | 0.25 | 0 |
| pH | 6.2 | 6.4 | 5.8 | 6.4 | 5.6 | 6.2 |

Filter 3

| | | | | | | |
|---|---|---|---|---|---|---|
| Chlorine | 0 | 0 | 0.3 | 0.1 | 0.4 | 0.1 |
| pH | 6.2 | 6.4 | 6 | 6.4 | 6.7 | 6.3 |

Filter 4

| | | | | | | |
|---|---|---|---|---|---|---|
| Chlorine | 0 | 0 | 0.3 | 0.1 | 0.4 | 0.1 |
| pH | 6.2 | 6.4 | 6 | 6.3 | 6.7 | 6.4 |

### Example 2

In a second example, to evaluate growth of hydroponic crops when aqueous solutions within the pH ranges achieved by the device systems and methods described herein, aqueous solutions comprising unique types and volumes of impurities were used in the hydroponic farming of lettuce plants. The pH of each solution was measured, and growth of the lettuce was observed visually and recorded over the course of 14 days.

### Preparation of Samples:

Six unique aqueous mixtures were prepared by mixing two cups of water with varying types and volumes of common impurities found in greywater and compared to the control solution (mixture 1, pure water). The pH of each sample was then measured and recorded. The table below depicts the impurity type, impurity volume, and measured pH value of each sample.

TABLE 3
Impurity type, impurity volume, and pH of samples.

| Sample Number | Impurity Type | Impurity Volume | | pH |
|---|---|---|---|---|
| Control | None | Not applicable | | 6.0 |
| 1 | Salt (NaCl) | 1 | teaspoon | 6.0 |
| 2 | Salt (NaCl) | 2 | teaspoons | 6.0 |
| 3 | Dish Soap | ⅛ | teaspoons | 7.3 |
| | (C₁₇H₃₅COO) | | | |
| 4 | Dish Soap | 1/16 | teaspoons | 6.6 |
| | (C₁₇H₃₅COO) | | | |
| 5 | Dish Soap | 1/32 | teaspoons | 6.4 |
| | (C₁₇H₃₅COO) | | | |
| 6 | 15-30-15 Fertilizer | 2.5 | teaspoons | 5.8 |

### Preparation of Crops:

Each head of lettuce was incised 2 inches from the base in the shape of an “X” and place in one of the sample solutions, with the incised side proximate to the sample solution. Solutions and lettuce heads were then stored in a cool, dry place. An LED Grow Light was used to accelerate growth. The lettuce plants were then observed optically, and size was measured and recorded for 14 days.

### Results:

The results of the observation and measurement of each plant on day one and every other day thereafter is depicted in Table 4 below. Notably the samples with pH values within the range of those achieved in by use of the filtration device with greywater, as described in Example 1, resulted in improved plant growth, thereby confirming that the filtration device described herein results in improved growth outcomes for hydroponic crops.

TABLE 4
Growth of lettuce plants, by day.

| | (day) | | | | | | | |
|---|---|---|---|---|---|---|---|---|
| Sample | 1 | 2 | 4 | 6 | 8 | 10 | 12 | 14 |
| Control | 0″ | 0″ | 1/16″ | ¼″ | ¾″ | ¾″ | ¾″ | ¾″ |
| 1 | 0″ | 0″ | browning | dead | dying | dead | dead | dead |
| 2 | 0″ | 0″ | browning | dead | dying | dead | dead | dead |
| 3 | 0″ | 0″ | sprouts | 1″ | 1.25″ | 1.75″ | 2.25″ | 2.25″ |
| 4 | 0″ | 0″ | ⅛″ | ¼″ | 1.75″ | 2.25″ | 2.75″ | 3″ |
| 5 | 0″ | 0″ | ¼″ | 1.25″ | 1.5″ | 2″ | 3″ | 4″ |
| 6 | 0″ | 0″ | ¼″ | ¼″ | 1″ | 2″ | 3″ | 4.1 |

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hydroponic farming device comprising:
a basin configured to receive an aqueous solution;
a filtration column in fluid communication with the basin via a first valve and comprising piping defining at least a first open space, wherein the first open space is configured to receive a filtration material therein; and
at least one dispersion tube in fluid communication with the filtration column via a second valve, the dispersion tube comprising dispersion piping defining a second open space,
wherein, in operation, the aqueous solution received by the basin is directed through the first open space such that the filtration material removes at least a portion of the impurities within the aqueous solution before the aqueous solution is directed to the at least one dispersion tube.

2. The hydroponic farming device of claim 1, wherein the first valve is a ball valve.

3. The hydroponic farming device of claim 1, wherein, in operation, the dispersion tube supports the filtration column and basin.

4. The hydroponic farming device of claim 1, wherein the dispersion tube defines an opening configured to receive a basket therein.

5. The hydroponic farming device of claim 1, wherein the dispersion tube further comprises a draining mechanism configured to drain an excess fluid.

6. The hydroponic farming device of claim 5, wherein the draining mechanism comprises a manipulatable cover.

7. The hydroponic farming device of claim 5, wherein the draining mechanism comprises a drain valve.

8. The hydroponic farming device of claim 1, wherein the at least one dispersion tube comprises a plurality of dispersion tubes.

9. The hydroponic farming device of claim 8, wherein the plurality of tubes comprises three tubes.

10. The hydroponic farming device of claim 8, wherein the plurality of tubes comprises four tubes.

11. The hydroponic farming device of claim 10, wherein the second valve is a five-way valve.

12. The hydroponic farming device of claim 8, wherein the at least one dispersion tube comprises five or more tubes.

13. The hydroponic farming device of claim 1, wherein one or more of the at least one dispersion tubes is in fluid connection with a plurality of secondary dispersion tubes.

14. A system for hydroponic farming comprising:
a hydroponic farming device, the hydroponic farming device comprising:
a basin configured to receive an aqueous solution;
a filtration column in fluid communication with the basin via a first valve and comprising piping defining at least a first open space; and
at least one dispersion tube in fluid communication with the filtration column via a second valve, the dispersion tube comprising dispersion piping defining a second open space, and
a filtration material disposed within the first open space of the hydroponic farming device,
wherein, in operation, the aqueous solution received by the basin is directed through the at least one open space such that the filtration material removes at least a portion of the impurities within the aqueous solution before the aqueous solution is directed to the at least one dispersion tube.

15. The system for hydroponic farming of claim 14, wherein the filtration material comprises rocks, sand, charcoal, wood chips, or any combination thereof.

16. The system for hydroponic farming of claim 14, further comprising a strainer positioned within a bottom portion of the filtration column.

17. The system for hydroponic farming of claim 16, further comprising a geotextile proximate to the strainer.

18. The system for hydroponic farming of claim 14, further comprising:
at least one basket configured to receive a crop therein,
wherein the dispersion tube further comprises at least one opening configured to receive the at least one basket.

19. A method of hydroponic farming comprising:
collecting an aqueous solution in a hydroponic farming device, the hydroponic farming device comprising:
a basin configured to receive an aqueous solution;
a filtration column in fluid communication with the basin via a first valve and comprising piping defining at least a first open space configured to receive a filtration material therein, wherein, in operation, the aqueous solution received by the basin is directed through the first open space such that the filtration material removes at least a portion of the impurities within the aqueous solution; and
at least one dispersion tube in fluid communication with the filtration column via a second valve, the dispersion tube comprising dispersion piping defining a second open space,
manipulating the first valve to allow the aqueous solution to flow from the basin to at least the first open space; and
manipulating the second valve to allow the aqueous solution to flow from the first open space to the at least one dispersion tube.

20. The method of claim 19, further comprising:
providing a basket configured to receive a crop;
placing the basket in an opening defined by the at least one of the dispersion tube;
placing a crop within the basket; and
utilizing a Kratky-based Method to grow the crop.
